(19) United States
(12) Patent Application Publication
(10) Pub. No.: US 2002/0194471 A1
(43) Pub. Date: Dec. 19, 2002

(54) Method and system for automatic LDAP removal of revoked X.509 digital certificates

(75) Inventors: Messaoud Benantar, Austin, TX (US); Neal W. Blackwood, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/881,916

(22) Filed: Jun. 14, 2001

(51) Int. Cl. H04L 9/00

(52) U.S. Cl. 713/158

(57) ABSTRACT

A method, system, apparatus, and computer program product are presented for managing digital certificates. When a certificate revocation list is received at a receiving application, a certificate management application removes any digital certificates that are listed within the certificate revocation list from the LDAP (Lightweight Directory Access Protocol) directories into which the certificates were published.

### BACKGROUND OF THE INVENTION

1. Field of the Invention

The present invention relates to an improved data processing system and, in particular, to a method and apparatus for multicomputer data transferring. Still more particularly, the present invention relates generally to computer-to-computer authentication.

2. Description of Related Art

Distribution of information across the Internet has continued to increase dramatically. Web-based and Internet-based applications have now become so commonplace that when one learns of a new product or service, one assumes that the product or service will incorporate Internet functionality into the product or service. New applications that incorporate significant proprietary technology are only developed when an enterprise has a significantly compelling reason for doing so. Many corporations have employed proprietary data services for many years, but it is now commonplace to assume that individuals and small enterprises also have access to digital communication services. Many of these services are or will be Internet-based, and the amount of electronic communication on the Internet is growing exponentially.

One of the factors influencing the growth of the Internet is the adherence to open standards for much of the Internet infrastructure. Individuals, public institutions, and commercial enterprises alike are able to introduce new content, products, and services that are quickly integrated into the digital infrastructure because of their ability to exploit common knowledge of open standards.

Concerns about the integrity and privacy of electronic communication have also grown with adoption of Internet-based services. Various encryption and authentication technologies have been developed to protect electronic communication. For example, an open standard promulgated for protecting electronic communication is the X.509 standard for digital certificates.

An X.509 digital certificate is an International Telecommunications Union (ITU) standard that has been adopted by the Internet Engineering Task Force (IETF) body. It cryptographically b-Lnds the certificate holder, presumably the subject name within the certificate, with its public cryptographic key. This cryptographic binding is based on the involvement of a trusted entity within the Internet Public Key Infrastructure for X.509) certificates (PKIX) called the certifying authority (CA). As a result, a strong and trusted association between the certificate holder and its public key can become public information yet remain tamper—proof and reliable.

An important aspect of this reliability is a digital signature that the certifying authority stamps on a certificate before it is released for use. When the certifying authority issues the certificate, the certifying authority generates a unique serial number by which the certificate is to be identified, and this serial number is stored within the “Serial Number” field within the X.509 certificate; a certifying authority certifies a holder's public key by cryptographically signing the certificate data structure. Subsequently, whenever the certificate is presented to a system for use of a service, its signature is verified before the subject holder is authenticated. After the authentication process is successfully completed, the certificate holder may be provided access to, i.e. authorized for, certain information, services, or other controlled resources.

PKIX also generates and manages a different: but closely related construct: an X.509 Certificate Revocation List (CRL). As noted above, a digital certificate provides an assurance, i.e. a certification, for a public key of the subject holding the certificate, whereas a CRL is the means by which a certifying authority announces the dissolution of the binding represented in a certificate. In other words, a CRL is the means by which the certifying authority declares that a previously issued certificate is no longer valid.

Certificates are revoked when the security of the certificate or associated keys have been compromised in some manner, such as loss, theft, modification, or unauthorized disclosure of the private key. Certificates are permanently invalidated and cannot be unrevoked, reinstated, or otherwise reactivated, and a user whose certificate has been revoked must request that a new certificate be issued. A CRL identifies a revoked certificate using the certificate's serial number; a revoked certificate's serial number appears within a list of serial numbers within the CRL. The revocation process is also certified by stamping the certifying authority's signature in the CRL data structure.

In order to be truly useful, digital certificates and CRL's must be widely available. To this end, the Certificate Management Protocol (CMP) of PKIX facilitates the publication of an issued certificate in an LDAP-based (Lightweight Directory Protocol) directory so that it can be retrieved for use by applications and security protocols. Generally, a comprehensive PKIX relies on a certificate issuance notification that the issuing certificate authority sends to a registration authority, which then performs the task of publishing the certificate. Immediate publishing of certificates to a public repository results in the immediate availability of those certificates for security-conscious services.

The advent of PKIX is expected to result in X.509 digital certificates proliferating in large numbers throughout public directories. However, the PKIX standards and specifications do not address the potential problem of repositories that become clogged with revoked certificates.

Therefore, it would be advantageous to have a method and system reducing potential problems with an increasing number of invalid digital certificates.

### SUMMARY OF THE INVENTION

A method, system, apparatus, and computer program product are presented for managing digital certificates. Typically, after a digital certificate is issued, the digital certificate is published into a certificate repository, which is usually an LDAP (Lightweight Directory Access Protocol) directory. The revocation of digital certificates is typically communicated by placing identifiers for digital certificates within a certificate revocation list, which are then used to determine whether or not a digital certificate has been revoked.

In the present invention, when a certificate revocation list is received by a certificate management application, which might be operated by a registration authority, one or more certificate repository removal requests are automatically generated for any digital certificates that are listed within the certificate revocation list.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a typical manner in which an entity obtains and uses a digital certificate;

FIG. 3 depicts a typical manner in which a digital certificate is generated and published via a registration authority;

FIG. 4 is a block diagram that depicts a manner in which a digital certificate is published and revoked via a registration authority in accordance with the present invention;

FIG. 5A shows some of the fields of a standard X.509 digital certificate;

FIG. 5B show some of the fields of an X.509 certificate revocation list; and

FIG. 6 is a flowchart depicting a process for automatic removal of revoked certificates from a certificate repository in accordance with a preferred embodiment of the present invention.

### DETAILED DESCRIPTION OF THE INVENTION

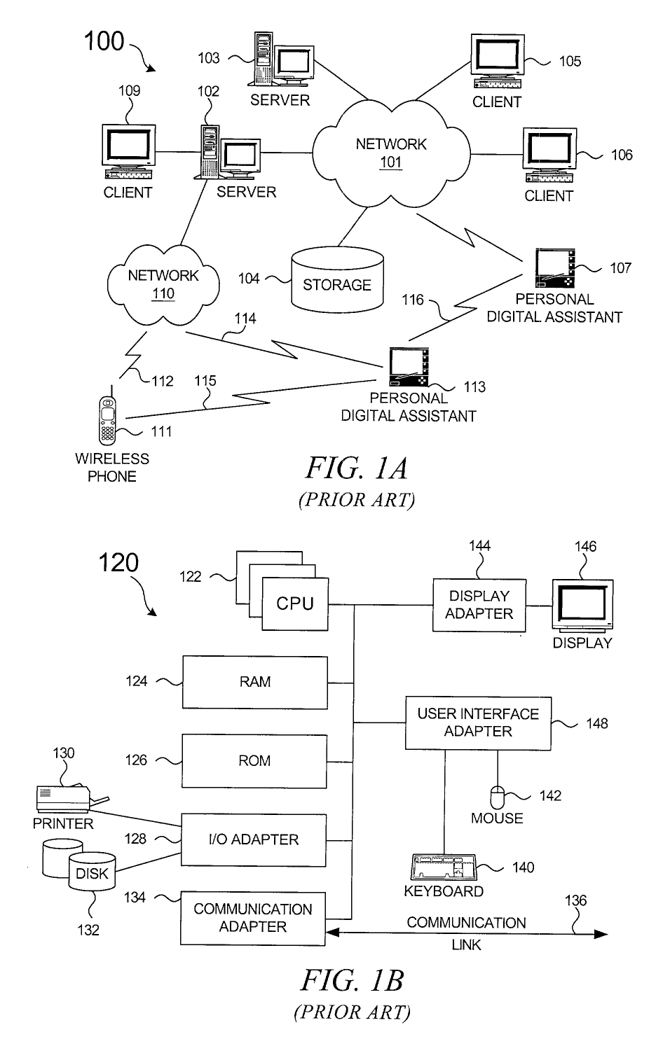

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to an authentication-related methodology within a distributed data processing environment. To accomplish this goal, the present invention manages digital certificates in a novel manner. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature.

The present invention is directed to a form of digital certificate management. A certificate is a digital document that vouches for the identity and key ownership of entities, such as an individual, a computer system, a specific server running on that system, etc. Certificates are issued by certificate authorities, A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

The X.509 standard is one of many standards that defines the information within a certificate and describes the data format of that information. The “version” field indicates the X.509 version of the certificate format with provision for future versions of the standard. This identifies which version of the X.509 standard applies to this certificate, which affects what information can be specified in it. Thus far, three versions are defined. Version 1 of the X.509 standard for public key certificates was ratified in 1988. The version 2 standard, ratified in 1993, contained only minor enhancements to the version 1 standard. Version 3, defined in 1996, allows for flexible extensions to certificates in which certificates can be extended in a standardized and generic fashion to include additional information.

In addition to the traditional fields in public key certificates, i.e. those defined in versions 1 and 2 of X.509, version 3 comprises extensions referred to as “standard extensions”. The term “standard extensions” refers to the fact that the version 3 of the X.509 standard defines some broadly applicable extensions to the version 2 certificate. However, certificates are not constrained to only the standard extensions, and anyone can register an extension with the appropriate authorities. The extension mechanism itself is completely generic.

Other aspects of certificate processing are also standardized. The Certificate Request Message Format (RFC 2511) specifies a format recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org.

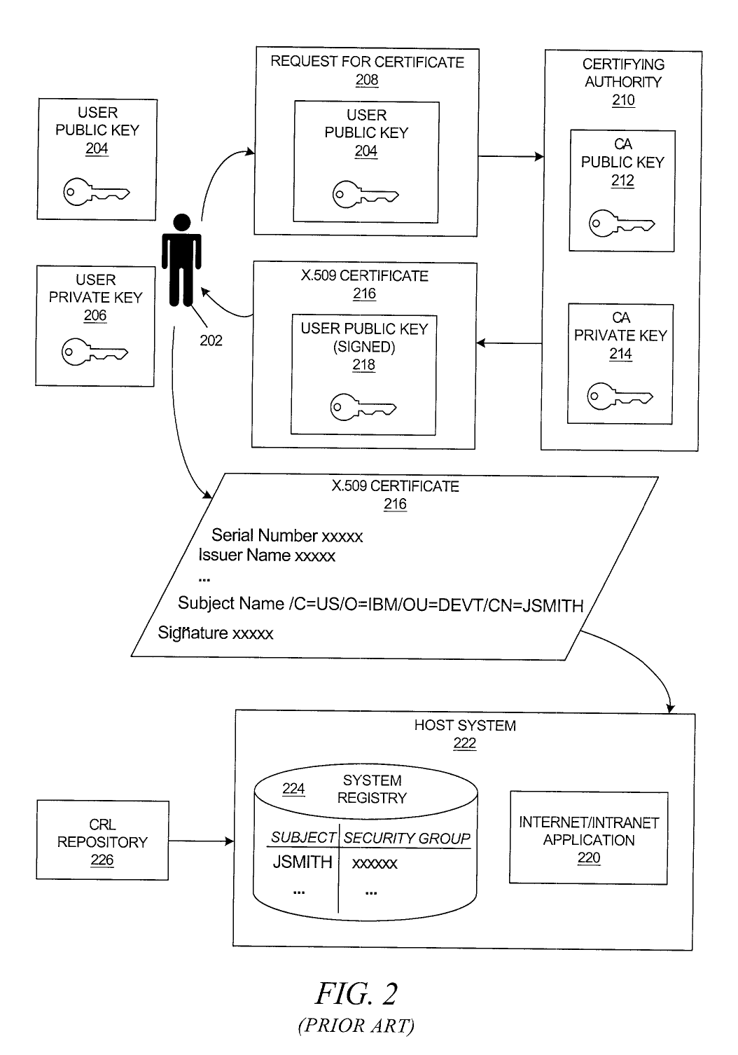

With reference now to FIG. 2, a block diagram depicts a typical manner in which an individual obtains and uses a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 218 that was signed with CA private key 214. User 202 receives newly generated digital certificate 216. An entity that receives digital certificate 216 may verify the signature of the CA by using CA public key 212, which is published and available to the verifying entity.

User 202 may then use its digital certificate 216 as necessary to engage in trusted transactions or trusted communications, such as to be authenticated to an Internet system or application. User 202 transmits X.509 digital certificate 216 to an Internet or intranet application 220 that comprises X.509 functionality for processing and using digital certificates in conjunction with host system 222. The entity that receives certificate 216 may be an application, a system, a subsystem, etc. Certificate 216 contains a subject name or subject identifier that identifies user 202 to application 220, which may perform some type of service for user 202.

Host system 222 may also contain system registry 224 which is used to authorize user 202 for accessing services and resources within system 222, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

In order to determine whether certificate 216 is still valid, host system 222 obtains a certificate revocation list (CRL) from CRI. repository 226 and compares the serial number within certificate 216 with the list of serial numbers within the retrieved CRL. If there are no matching serial numbers and the certificate has been otherwise verified in an appropriate manner, then host system 222 authenticates user 202. If the CRL has a matching serial number, then certificate 216 should be rejected, and host system 222 can take appropriate measures to reject the user's request for access to any protected resources.

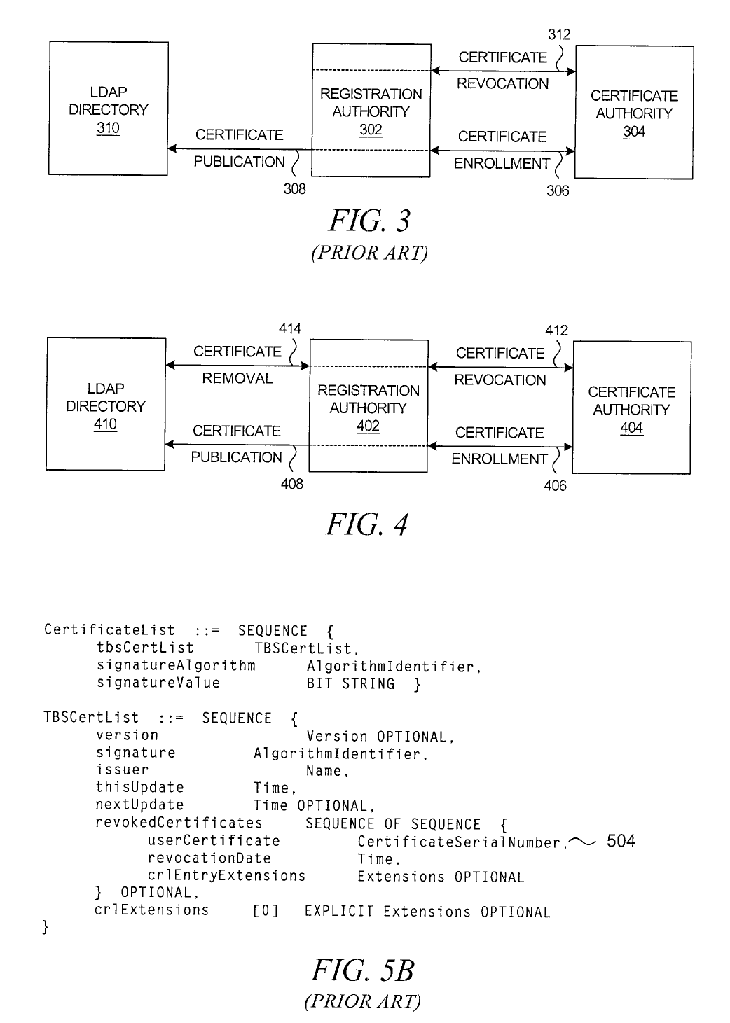

With reference now to FIG. 3, a block diagram depicts a typical manner in which a digital certificate is generated and published via a registration authority. As previously shown in FIG. 2, a requesting user or entity can interact directly with a certifying authority as a client of the certification process to obtain a digital certificate. In many cases, however, a requesting user or requesting entity interacts directly with a registration authority (RA) in order to obtain a digital certificate. A registration authority, which is sometimes referred to as a local registration authority (LRA), is an optional component in the X.509 PKI; it is often a separate agent that acts as an intermediary to perform personal authentication tasks to register users and establish their identity during the certification process.

A local registration authority may require physical presentation of identity documents by the person who is applying for a digital certificate so that the local registration authority can verify the identity of the person. The local registration authority may have many duties, such as verifying the identity of those individuals attempting to obtain digital certificates and then requesting the issuance of digital certificates from the certifying authority. Although a digital certificate may be generated or issued by a certifying authority, the local registration authority may be responsible for ensuring that the certificate can be used and managed. Therefore, after receiving a digital certificate, the registration authority can perform certain management operations with the digital certificate on behalf of an individual, such as publishing the digital certificate into an LDAP directory.

For example, a corporation may have a department that acts as a local registration authority to obtain and manage digital certificates for the corporation's employees. The local registration authority verifies the authenticity of the identity documents that the employee presents to the corporation and then obtains and manages a digital certificate for the employee. At some point in time, if the employee leaves a corporation, then the local registration authority can initiate a certificate revocation process for the digital certificate that has been issued to the employee.

FIG. 3 shows the interaction of a registration authority with a certificate authority. In contrast to FIG. 2, though, FIG. 3 does not show the interaction of an individual in the certificate issuance process. Registration authority 302 verifies the identity of a user who is applying for a digital certificate. Registration authority 302 submits a certificate request to certificate authority 304, which is responsible for generating or issuing the certificate, shown as the certificate enrollment process 306 between registration authority 302 and certificate authority 304. Upon receiving a newly issued certificate, registration authority 302 then performs publication operation 308 into LDAP directory 310; LDAP directory 310 is supported by an LDAP engine, server, or application that performs storage and retrieval processes with respect to a datastore in accordance with the LDAP protocol. At some later point in time, registration authority 302 may engage in certificate revocation process 312 with certificate authority 304 in order to ensure that a specific certificate is placed onto a certificate revocation list so that the certificate can no longer be used.

There are many commercially available systems that have been created using PKIX standards and specifications, as partially shown in the background information on the processing of digital certificates provided in FIG. 2 and FIG. 3. With the proliferation of interconnected networks, it is expected that digital certificates will be used for many new applications. The advent of PKIX is expected to result in X.509 digital certificates proliferating in large numbers throughout public directories. However, the PKIX standards and specifications do not address the potential problem of repositories that become clogged with revoked certificates.

The present invention recognizes that there is a need for a type of garbage collection for digital certificates that have been revoked. More specifically, the present invention is directed to a methodology for automatic removal of a certificate from an LDAP repository upon its revocation as explained in more detail further below.

With reference now to FIG. 4, a block diagram depicts a manner in which a digital certificate is published and revoked via a registration authority in accordance with the present invention. In a manner similar to FIG. 3, FIG. 4 shows the interaction of a registration authority with a certificate authority. Registration authority 402 verifies the identity of a user who is applying for a digital certificate. Registration authority 402 submits a certificate request to certificate authority 404, which is responsible for generating or issuing the certificate, shown as the certificate enrollment process 406 between registration authority 402 and certificate authority 404. Upon receiving a newly issued certificate, registration authority 402 then performs publication operation 408 into LDAP directory 410. At some later point in time, registration authority 402 may engage in certificate revocation process 412 with certificate authority 404 in order to ensure that a specific certificate is placed onto a certificate revocation list so that the certificate can no longer be used.

In addition, FIG. 4 shows that registration authority 402 confirms that the certificate has been placed onto a certificate revocation list, after which registration authority 402 performs certificate removal process 414 with LDAP directory 410 to remove the certificate from the LDAP directory.

PKIX provides for a CRL announcement message that may be distributed by the certificate authority when the certificate authority issues (or possibly prior to issuing) one or more new certificate revocation lists. When a registration authority receives a CRL announcement message, the registration authority ensures that each certificate that is included in the certificate revocation list is removed from any directories with which the registration authority is associated.

LDAP directory operations should be performed as efficiently as possible. LDAP directory entries can store many information items, such as a subject's name, organization, etc.; a subject's digital certificate would be stored within a directory entry in association with other information for a subject. However, a certificate revocation list identifies a revoked certificate through the certificate's serial number only.

Therefore, in order to ensure the speedy removal of a revoked certificate from an LDAP directory when a certificate revocation list is announced, a preferred embodiment of the present invention ensures that a newly published certificate is initially stored in an LDAP directory with its corresponding serial number attribute, which is available within an X.509 digital certificate. In this manner, the LDAP directory can be efficiently searched for directory entries containing serial numbers that match the serial numbers in the certificate revocation list, and no changes would be required of the PKIX/CMP protocols.

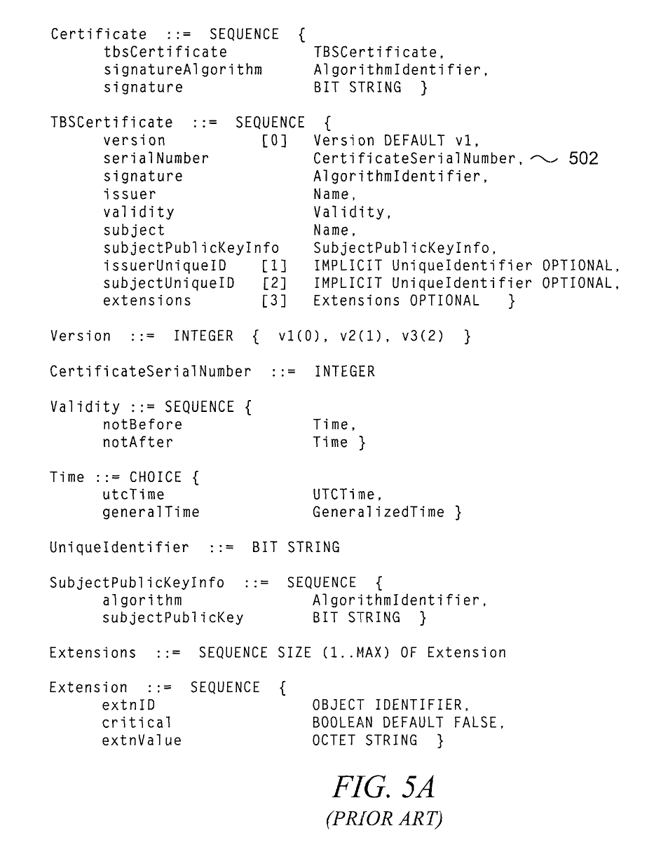

With reference now to FIG. 5A, some of the fields of a standard X.509 digital certificate are shown. The constructs shown in FIG. 5A are in Abstract Syntax Notation 1 (ASN.1) and are defined within the X.509 standard. An X.509 digital certificate includes serial number 502 for identifying the digital certificate.

With reference now to FIG. 5B, some of the fields of an X.509 certificate revocation list are shown. Each revoked certificate is identified in a CRL using the construct shown in FIG. 5B, which is also in ASN.1 notation. A standard CRL contains one or more entries for revoked certificates with one revoked certificate specified per entry. An X.509 certificate revocation list includes serial number 504 for identifying a revoked digital certificate. Definitions for digital certificates and certificate revocation lists are specifically recited within “Internet X.509 Public Key Infrastructure Certificate and CRL Profile”, IETF RFC 2459, January 1999.

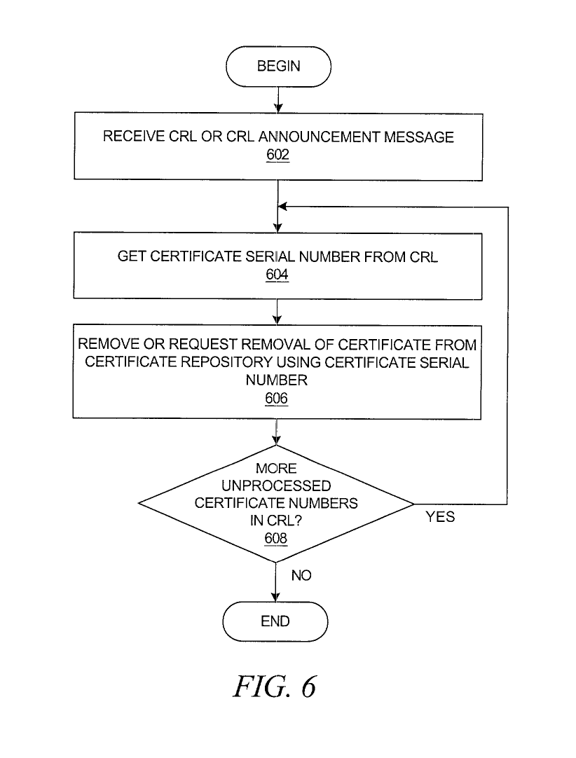

With reference now to FIG. 6, a flowchart depicts a process for automatic removal of revoked certificates from a certificate repository in accordance with a preferred embodiment of the present invention. The process begins with the receipt of a certificate revocation list or a CRL announcement message from a certifying authority (step 602). The certificate revocation list or the CRL announcement message may be received at a registration authority or some other type of application that is responsible for managing digital certificates on behalf of an entity or an organization.

A certificate serial number is retrieved from a certificate revocation list (step 604), and the retrieved serial number is used to generate a request to remove the certificate that corresponds to the serial number from the certificate repository (step 606), which would be sent to one or more datastores as necessary to ensure that the certificate is removed from each datastore. Assuming that a CRL announcement message is received at a registration authority and that the registration authority interacts with an LDAP directory, the registration authority may send an appropriate message to the LDAP engine that manages the directory in order to request the removal of the corresponding certificate if it exists within the directory. If the registration authority publishes certificates into multiple directories, then the registration authority would attempt to delete the corresponding certificate from each directory.

A determination is then made as to whether or not all listed certificate serial numbers within the certificate revocation list have been processed (step 608). If not, then the process branches back to step 604 to process another serial number; if so, then the process is complete.

It should be noted that the methodology of the present invention is generic enough to allow for its operation using a variety of message protocols and certificate repositories and that the present invention is not limited to being implemented within only the X.509 set of specifications and standards.

The advantages of the present invention should be apparent in view of the detailed description of the invention that is provided above. In the prior art, a potential problem arises in PKIX because of the fact that the PKIX standards and specifications do not address the potential problem of repositories that become clogged with revoked certificates. Moreover, when a certificate is found within a repository, the certificate must be verified by checking whether the certificate has been included within a certificate revocation list.

The present invention provides a methodology for automatic removal of a certificate from an LDAP repository upon its revocation. Immediate LDAP removal of a revoked certificate not only results in a systematic cleanup method but also allows a potential user or application that is looking up an entity's certificate in an LDAP repository to quickly determine that a certificate does not exist. The inquiring user or application can then avoid any attempt at starting a secure communication session with that particular entity.

Moreover, since a certificate would not be found within the repository for the entity, there would be no certificate to be verified. In other words, the inquiring user or application would avoid the certificate verification process in which a retrieved certificate must be verified by checking whether the certificate has been included within a certificate revocation list.

Furthermore, many inquiring users or applications might not have access to the latest certificate revocation lists; if the retrieved certificate were included in a newly issued certificate revocation list, the inquiring user or application might attempt to use a revoked certificate that was retrieved from the repository. With the present invention, no certificate would be retrieved, thereby eliminating such errors. Overall, security risks are reduced by automatically removing the certificates from a certificate repository when certificates are revoked.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing a digital certificate within a data processing system, the method comprising:
receiving a certificate revocation list; and
in response to receiving the certificate revocation list, automatically requesting removal of the digital certificate from a certificate repository.

2. The method of claim 1 further comprising:
extracting a certificate serial number from the certificate revocation list, wherein the certificate serial number has been associated with the digital certificate by the certifying authority; and
requesting removal of the digital certificate from the certificate repository using the certificate serial number of the digital certificate.

3. The method of claim 1 further comprising:
receiving a certificate revocation list announcement message; and
extracting the certificate revocation list from the certificate revocation list announcement message.

4. The method of claim 1 wherein the digital certificate and the certificate revocation list are formatted according to X.509 standards.

5. The method of claim 1 wherein the certificate repository is an LDAP (Lightweight Directory Access Protocol) directory.

6. The method of claim 1 wherein a registration authority receives the certificate revocation list and generates a certificate removal request.

7. A method for managing a digital certificate within a data processing system, the method comprising:
receiving a certificate revocation list, wherein the certificate revocation list identifies at least one digital certificate that has been revoked by a certifying authority;
extracting a certificate serial number from the certificate revocation list, wherein the certificate serial number uniquely corresponds to a digital certificate; and
in response to receiving the certificate revocation list, automatically requesting removal of the digital certificate from an LDAP (Lightweight Directory Access Protocol) directory using the extracted certificate serial number.

8. The method of claim 7 further comprising:
receiving a certificate revocation list announcement message; and
extracting the certificate revocation list from the certificate revocation list announcement message.

9. The method of claim 7 wherein the digital certificate and the certificate revocation list are formatted according to X.509 standards.

10. An apparatus for managing a digital certificate, the apparatus comprising:
means for receiving a certificate revocation list; and
means for automatically requesting removal of the digital certificate from a certificate repository in response to receiving the certificate revocation list.

11. The apparatus of claim 10 further comprising:
means for extracting a certificate serial number from the certificate revocation list, wherein the certificate serial number has been associated with the digital certificate by the certifying authority; and
means for requesting removal of the digital certificate from the certificate repository using the certificate serial number of the digital certificate.

12. The apparatus of claim 10 further comprising:
means for receiving a certificate revocation list announcement message; and
means for extracting the certificate revocation list from the certificate revocation list announcement message.

13. The apparatus of claim 10 wherein the digital certificate and the certificate revocation list are formatted according to X.509 standards.

14. The apparatus of claim 10 wherein the certificate repository is an LDAP (Lightweight Directory Access Protocol) directory.

15. The apparatus of claim 10 wherein a registration authority receives the certificate revocation list and generates a certificate removal request.

16. An apparatus for managing a digital certificate, the apparatus comprising:
means for receiving a certificate revocation list, wherein the certificate revocation list identifies at least one digital certificate that has been revoked by a certifying authority;
means for extracting a certificate serial number from the certificate revocation list, wherein the certificate serial number uniquely corresponds to a digital certificate; and
means for automatically requesting removal of the digital certificate from an LDAP (Lightweight Directory Access Protocol) directory using the extracted certificate serial number in response to receiving the certificate revocation list.

17. The apparatus of claim 16 further comprising:
means for receiving a certificate revocation list announcement message; and
means for extracting the certificate revocation list from the certificate revocation list announcement message.

18. The apparatus of claim 16 wherein the digital certificate and the certificate revocation list are formatted according to X.509 standards.

19. A computer program product on a computer readable medium for use in a data processing system for managing a digital certificate, the computer program product comprising:
instructions for receiving a certificate revocation list, wherein the certificate revocation list identifies at least one digital certificate that has been revoked by a certifying authority;
instructions for extracting a certificate serial number from the certificate revocation list, wherein the certificate serial number uniquely corresponds to a digital certificate; and
instructions for automatically requesting removal of the digital certificate from an LDAP (Lightweight Directory Access Protocol) directory using the extracted certificate serial number in response to receiving the certificate revocation list.

20. The computer program product of claim 19 further comprising:
instructions for receiving a certificate revocation list announcement message; and
instructions for extracting the certificate revocation list from the certificate revocation list announcement message.

21. The computer program product of claim 19 wherein the digital certificate and the certificate revocation list are formatted according to X.509 standards.
